(19) United States
(12) Patent Application Publication
(10) Pub. No.: US 2013/0261232 A1
(43) Pub. Date: Oct. 3, 2013

(54) SUPER CONCENTRATED POLYMER-BINDER COMPOSITE

(71) Applicant: Arr-Maz Products, L.P., Mulberry, FL (US)

(72) Inventors: James J. Barnat, Tulsa, OK (US); Vincent Vopat, Tulsa, OK (US)

(73) Assignee: Arr-Maz Products, L.P., Mulberry, FL (US)

(21) Appl. No.: 13/901,018

(22) Filed: May 23, 2013

Related U.S. Application Data
(63) Continuation-in-part of application No. 12/631,305, filed on Dec. 4, 2009.
Application No. 12/631,305 is a continuation-in-part of application No. 12/173,571, filed on Jul. 15, 2008.
Application No. 12/173,571 is a continuation-in-part of application No. 11/841,441, filed on Aug. 20, 2007, now abandoned.

(51) Int. Cl. C08L 95/00

(52) U.S. Cl. CPC C08L 95/00
USPC 524/71

(57) ABSTRACT

A pre-processed polymer concentrate in binder comprising a binder and at least one polymer that contains at least 60% conjugated diene where the polymer comprises greater than 26% by weight of the pre-processed polymer concentrate in binder, where the pre-processed polymer concentrate in binder is capable of incorporating quickly into diluent binder under low shear conditions and where the pre-processed polymer concentrate in hinder does not comprise chlorinated polymer.

### SPONSORED RESEARCH OR DEVELOPMENT

Not Applicable.

### CROSS-REFERENCE TO RELATED APPLICATIONS

This application is a continuation in part of application Ser. No. 12/631,305 filed Dec. 4, 2009, which was a continuation-in-part of application Ser. No. 12/173,571 filed Jul. 15, 2008 titled “Polymer-Binder Composite and Methods of Making and Using Same.” which was a continuation-in-part of application Ser. No. 11/841,441 filed Aug. 20, 2007 titled “Method and Product of Making a Polymer-Binder Composite.” All parent applications are incorporated by reference herein as if reproduced in full below.

### BACKGROUND OF THE INVENTION

1. Field of the Invention

The present invention relates to a super concentrated polymer-binder composite. More specifically, the present invention relates to a polymer-binder composite with high polymer concentrations and high loose bulk density such that the polymer-binder composite may be incorporated into asphalt quickly and fully.

2. Description of the Related Art

It is desirable to add polymers to asphalt to enhance the theological properties of the mixture. Mechanical means are required to add and mix the polymers into the asphalt to create the modified hinder with enhanced rheological properties.

Polymers used in the asphalt industry have high molecular weight and multiple configurations. The molecular weight typically ranges from 50,000 to 500,000. Polymers can be in linear or non-linear forms or combinations thereof. The non-linear forms may be radial forms and may contain three or more appendages. Polymers are processed and pelletized to produce a dense entangled mass. The entanglement increases with molecular weight and radial configuration. The degree of entanglement hinders incorporation into asphalt; hence, it requites greater time and energy to disentangle.

Polymers may incorporate in asphalt and never fully disentangle. Polymer modified asphalt incorporating partially entangled polymers provides inferior rheological properties than the polymers that are fully disentangled. Higher shear, higher temperatures, or longer mix times will help fully disentangle polymers when being incorporated into asphalt. However, these additional energies or processing time are costly and a compromise must be achieved between polymer efficiency and the cost to manufacture.

Polymers can be heated and mixed to aid incorporation into the asphalt binder. Higher temperatures increase the rate of incorporation in the binder, which is favorable because quicker incorporation reduces batch to batch cycle times and may reduce overall capital costs. However, higher heat has a negative effect on the polymer due to thermal degradation.

Additionally, when polymers are mixed in hot asphalt, the mechanical shear of mixing aids incorporation and helps reduce batch to batch cycle times. Several types of mixing are available like low shear paddle mixers, high shear devices like a polymer mill, and the like. Low shear devices like paddle mixers from Mix Mor, Lightnin, and the like are desirable due to the low cost to install, maintain, and operate. The mixers move the liquid asphalt in the tank while the polymer increases in temperature and starts incorporation. The polymer slowly incorporates in the asphalt or binder requiring a significant amount of time. High shear devices in the known art are similar to Krup and Buckam Supratron homogenizer, IKA single or multi-stage high shear mixers, Dalworth Machine Tool polymer mill, Ross multi-stage, Low Profile X Design, Mega Shear designs, Silverston high shear mixers, and the like. These high shear devices mechanically shear the solid polymer in the liquid, asphalt via a continuous circulation loop through a high shear zone. This may be an inline process or achieved within a tank. The process requires a high energy input to operate the high shear device. The polymer is heated and the incorporation is aided by the mechanical action of the shearing device. The high shear device incorporates polymer into asphalt quicker than a low shear devices leading to low batch to batch cycle times. However, high shear devices are expensive to install, maintain, and operate.

In practice, incorporation of polymers into asphalt can be visually assessed. Polymers are added to hot asphalt and mixed. Samples of this mixture are filtered through approximately 20 mesh screens and assessed for unincorporated polymers. When about 90% incorporation is achieved, no filtrate can be collected and the mixture looks smooth and homogeneous. Thereafter, additives or cross link packages may be added with additional mixing. The resultant mixture is pumped to other tanks, processes or transport vessels. The remainder of the polymer is incorporated through this subsequent handling.

Polymers for the asphalt industry are generally produced as a porous pellet or a powder. The porous pellet is produced in such a way as to create as much specific surface area as possible. Similarly, powdered polymers have a very high specific surface area. Powdered polymers require an additional manufacturing step of grinding the polymer to reduce its size to that of a powder. This is an expensive process and is only used when processing times become excessively long.

The conventional belief is that high specific surface area allows better contact between, the asphalt and the polymer, enhances incorporation, and potentially reduces batch to batch cycle times. Polymer manufacturers routinely offer porous pellets or powders as the physical form of the polymer product to the paving and other industries. Higher specific surface area also creates a very low loose hulk density of the pellet or powder. High density pellets are not used due to excessive processing times to incorporate into asphalt.

Despite their purported advantages, in practice, polymers in the form of low density porous pellets or powders have a tendency to float in hot asphalt. The heat transferred to the polymer softens the polymers, makes them tacky, causing the polymers to quickly adhere to the mixing devices as well as the vessel. These agglomerated particles also grow in size and may not be incorporated into asphalt.

Current art tries to avoid polymer agglomeration by utilizing special tank mixing equipment. Special mixer configurations, placement, and high energy motors help minimize agglomeration. These mixers are expensive and consume vast amounts of energy in operation.

Current art feeds the porous polymer pellets or powders into hot asphalt at a rate that allows tank mixers to integrate the polymer in the hot asphalt. The slow addition of the porous polymer pellets or powders helps minimize agglomeration. However, the slower polymer addition increases batch to batch cycle times.

Analog polymers with a similar molecular weight and configuration but with a high loose bulk density versus low loose bulk density can be added much quicker to hot asphalt without the need for complex mixing. The higher loose bulk density polymers may be added to the hot asphalt quickly with reduced potential for agglomeration. However, these higher loose bulk density polymer particles are correspondingly very slow to incorporate and greatly increase the batch to batch cycle times.

Capital costs to add and incorporate polymers to hot asphalt are large. Polymers can be processed into concentrates in hot asphalt and it is preferred to transport polymer concentrate in asphalt from the expensive processing facility to a lower cost receiving facility that dilutes the processed concentrate to the desired concentration. The expensive processing facility bears the capital cost of the complex handling and mixing equipment while multiple receiving facilities are only required to dilute the pre-processed concentrate with diluent asphalt.

Polymer concentrate in asphalt should be sufficiently combined so that further processing by the receiving facility only requires minor mixing when added to diluent asphalt. Additionally, a processed polymer concentrate in asphalt should be sufficiently incorporated so that there is no more than minimal phase separation of the polymer and the asphalt.

Concentrates of polymer in asphalt have high polymer content generally in excess of end-use requirements, and the processed concentrate is later diluted with additional asphalt to meet requirements. Transportation costs are high and the use of processed polymer concentrates require less transportation to the receiving facility and enable the polymer to be shipped at a lower cost.

Concentrates of polymer in asphalt can be transported as hot liquids. The addition of polymers into asphalt greatly increases the viscosity of the resultant mixture. The maximum concentration of the polymer in asphalt is limited by the maximum viscosity that can be processed and transported. Polymer concentrates in asphalt generally are limited to 6% to 9% polymer concentration based on the weight of the mixture but some novel polymers can be manufactured and transported up to 26%.

Higher concentrations of polymers in asphalt exhibit correspondingly higher viscosities. These viscosities can be reduced by elevating the liquid temperature. Using excessive temperatures to maintain sufficiently fluidity to handle the processed polymer concentrate in asphalt may degrade the polymer and limits the concentration of polymers in asphalt to 6% to 9% and up to 26% with some novel polymers. Temperatures in excess of 177° C. may diminish polymer quality and are generally avoided for prolonged periods of time.

Current US specifications that require polymer modification are routinely and preferably met with non-chlorinated styrene-butadiene type polymers. Butadiene is a conjugated diene that may be crosslinked to build molecular weight which increases rheological properties. Conjugated diene also helps incorporate the polymer into the asphalt.

Alternately, cross linked conjugated diene minimizes the ability of the polymer to incorporate into asphalt. It is imperative to completely incorporate the polymer into asphalt before any cross linking talks place. Hence, pre-processing polymer concentrates must not be cross linked or the resultant pre-processed polymer will not incorporate sufficiently into asphalt.

Polymer concentrates in asphalt can be transported at ambient temperature by packaging into disposable containers as a solid. The concentrate is poured into a container and cooled to solidify. The container is loaded onto and tied together on platforms to facilitate shipment. The platforms containing polymer concentrate are shipped at ambient temperature to the receiving facility. The semi-solid polymer concentrate is manually removed from the transportation platform, separated from the packaging materials, and added to the process to reduce the polymer content to meet requirements. Polymer concentrates in asphalt generally are limited to 6% to 9% polymer concentration based on the weight of the mixture but some novel polymers can be manufactured up to 26% concentrates. The cost to package, transport, and utilize the polymer concentrate at the receiving facility becomes extremely expensive and is rarely used as compared to transporting hot liquid polymer concentrates in asphalt at lower concentrations.

Polymer concentrates in asphalt can be pelletized by conventional means like a strand pelletizer, an under water pelletizer, and the like. These operations are never used due to the fact that pelletized polymer in asphalt at polymer concentrations of 6%, 9% or even 26% are sufficiently soft at ambient storage temperatures and tend to re-agglomerate and revert to a single mass.

Based on the foregoing, it is desirable to create a pre-processed polymer concentrate in asphalt at concentrations greater than 26%, greater than 50%, greater than 75%, greater than 85%, or greater than 90%.

It is also desirable to create pre-processed polymer concentrate that is not cross linked.

It is also desirable to create pre-processed polymer concentrates in asphalt that can be cost-effectively shipped and handled at ambient temperature.

It is also desirable to create a pre-processed polymer concentrate in asphalt that can be pelletized and sufficiently maintain the individual nature of the pellet to facilitate storage, handling, and transportation.

It is also desirable to utilize a pre-processed polymer in asphalt that has a loose bulk density sufficiently high to minimize the polymer floating in diluent asphalt, thus minimizing the cost and complexity of mixing systems in the diluent asphalt tank and facilitating expedient addition of the polymer without the risk of agglomeration.

It is also desirable to utilize a pre-processed polymer concentrate that incorporates quickly into diluent asphalt under low shear conditions to both minimize capital costs and batch to batch cycle times.

It is also desirable to achieve maximum polymer efficiency by fully disentangling polymers without compromising the cost to incorporate polymers into asphalt.

### SUMMARY OF THE INVENTION

A pre-processed polymer concentrate in binder comprising a binder and at least one polymer where the polymer comprises greater than 26% by weight of the pre-processed polymer concentrate in binder, where the pre-processed polymer concentrate in binder is capable of incorporating quickly into diluent binder under low shear conditions and where the pre-processed polymer concentrate in binder does not comprise chlorinated polymer. The polymer may comprise greater than 50%, greater than 75%, or greater than 85% by weight of the pre-processed polymer concentrate in binder.

The pre-processed polymer concentrate in binder may be made into pellets that maintain an individual pellet shape. The pre-processed polymer concentrate may have a loose bulk density of greater than 28 lbs/ft³, greater than 30 lbs/ft³, or greater than 32 lbs/ft³. The pre-processed polymer concentrate in binder may be stable at normal temperatures and may be capable of being stored and transported without heating.

The binder may comprise greater than 25% bituminous asphalt. The binder may comprise used motor oil re-refined used motor oil constituents and/or byproducts. The binder may comprise bio-based oils, crude or refined products, and/or byproducts. The binder assists the pre-processed polymer concentrate to mix in the mega shear device without generating conditions that initiate and propagate cross linking.

The pre-processed polymer concentrate in binder may be produced by a method comprising adding a binder to a mega shear device and adding at least one polymer to the mega shear device in a sufficient quantity to produce a pre-processed polymer concentrate in binder with greater than 26% polymer by weight of the pre-processed polymer concentrate in binder, where the pre-processed polymer concentrate in binder is capable of incorporating quickly into diluent binder under low shear conditions, and where the pre-processed polymer concentrate in binder does not comprise chlorinated polymer. The binder and at least one polymer may be subjected to mixing where scalar shear quantity is greater than about 250, greater than about 1,000, or greater than about 1,500. The binder and at least one polymer may be subjected to mixing where energy utilized is greater than about 0.025 kW/kg energy in the high shear device, greater than about 0.05 kW/kg energy in the high shear device, or greater than about 0.10 kW/kg energy in the high shear device. The binder and at least one polymer may be processed at greater than 100 psi.

The method may further comprise making the pre-processed polymer concentrate in binder into pellets that maintain an individual pellet shape. The pre-processed polymer concentrate may have a loose bulk density of greater than 28 lbs/ft³, greater than 30 lbs/ft³, or greater than 32 lbs/ft³. The pre-processed polymer concentrate in binder may be stable at normal temperatures and may be capable of being stored and transported without heating.

The binder may be comprised of greater than 25% bituminous asphalt. The binder may comprise used motor oil, re-refined used motor oil constituents and/or byproducts, or may comprise bio-based oils, crude or refined products, and/or byproducts. The pre-processed polymer concentrate in binder may capable of being dispersed in diluent binder in less than three hours, less than two hours, or less than one hour.

### DETAILED DESCRIPTION OF THE INVENTION

The present invention relates to a pre-processed polymer concentrate in asphalt. More specifically, a pre-processed polymer concentrate in asphalt at polymer concentrations greater than 26%, greater than 50%, greater than 65%, greater than 75%, greater than 85%, or even greater than 90%; that can be cost-effectively shipped and handled at ambient temperature; that can be pelletized and sufficiently maintain the individual nature of the pellet to facilitate storage, handling, and transportation; that has a loose bulk density sufficiently high to minimize the polymer floating in diluent asphalt, thus minimizing the cost and complexity of mixing systems in the diluent asphalt tank and facilitating expedient addition of the polymer without the risk of agglomeration; and that incorporates quickly and fully into diluent asphalt under low shear conditions to both minimize capital costs and batch to batch cycle times.

The present invention employs mega shear mixing like an extruder. Mega shear is defined by a device that can achieve a Scalar Shear Quantity of at least 250, preferably at least 1000, more preferably at least 1500. If an extruder is employed, it can be a single screw but preferably a double screw type. If the extruder is a double screw type, then it can be counter rotating but preferably is co-rotating type. These mega shear devices may operate at pressures greater than 100 psi and can mix the polymer and asphalt or other binders and additives together in preferably less than an hour, more preferably in less than 30 minutes, and most preferably in less than 3 minutes to produce the pre-dispersed polymer concentrate in asphalt.

Binders employed in the present invention may be any type of bituminous material or hydrocarbon resin, including, but not limited to, petroleum based asphalt or coal based coal tar or pitch. Typical bituminous material that can be employed as a binder in the present invention would include, but are not limited to, asphalt cement (AC), pitch, coal tar, asphalt, vacuum tar bottoms (VTB), resid, performance grade (PG) asphalts, flux, or petroleum products derived thereof. Binders can be any combination of bituminous or petroleum products. If binders are bituminous asphalt, they may be PG graded, viscosity graded or penetration graded materials. Also, binders can be >25% bituminous asphalt, preferably >50% bituminous asphalt, more preferably >75% bituminous asphalt, and most preferably >90% bituminous asphalt. Binders may also include used motor oil and used motor oil extracts and the like. Additionally, binders may also include bio-based oils, crude or refined products, byproducts and the like. The binders may not be polymer modified by chlorinated polymer.

Although higher shear rates are achievable by various means, the scalar shear quantity (the product of shear rate and resident time within, this shear zone), resident time, or energy per unit mass may be utilized in the production of the pre-dispersed polymer concentrate in asphalt.

The scalar shear quantity (Sᵣ*Resident time) represents the amount of shear exerted upon the materials within the varying shear zones. This scalar shear quantity is greater than 250, preferably greater than 1000, and more preferably greater than 1500 to produce the pre-dispersed polymer concentrate in asphalt.

Specific energy is defined as the amount of energy utilized to produce the pre-dispersed polymer concentrate in asphalt. Preferably the specific energy is greater than 0.025 kw/kg (kilowatt per kg), more preferably greater than 0.05 kw/kg, and most preferably 0.10 kw/kg.

Concentrations of pre-dispersed polymer concentrate in asphalt greater than 90 wt. % polymer are achievable with this method. The pre-dispersed polymer concentrate in asphalt may be extruded in a long string. When the pre-dispersed polymer concentrate in asphalt is cooled, it can then be cut into pellets. These pellets are stable at normal temperatures and can be stored without heating and transported without heating to secondary mixing facilities. The pre-dispersed polymer concentrate in asphalt pellets have an additional benefit of mixing within less than 3 hours, preferably within less than 2 hours, and most preferably less than 1 hour when added to diluent binder in the low shear mixers found at the secondary mixing facilities.

This method is capable of producing pre-dispersed polymer concentrates in asphalt with a polymer concentration of less than 99.9 wt. %, with an asphalt concentration of less than 74 wt. % and with an additive concentration of less than 50 wt. %. At least one polymer and at least one binder are fed into the mega shear device like an extruder to produce the pre-dispersed polymer concentrate in asphalt. Optionally, at least one additive is also fed into the mega shear device with the polymer and binder to produce the pre-dispersed polymer concentrate in asphalt. The pre-dispersed polymer concentrate may not comprise chlorinated polymer.

The pre-dispersed polymer concentrate in asphalt may have a loose bulk density sufficiently high to minimize the polymer floating in diluent asphalt when the concentrate is mixed with diluent asphalt. The loose bulk density may be greater than 28, greater than 30, or greater than 32 pounds per cubic foot.

For the examples 1 through 3, the pre-dispersed polymer concentrate in asphalt was produced with a co-rotating twin screw extruder in accordance to the following processing parameters:
specific energy of about 1.04-1.10 kw/kg,
residence time of about 23.2-44.0 seconds,
scalar shear quantity of about 1,382-1,497,
RPM of 600-650.

### EXAMPLE #1

Suncor PG 58-28 diluent asphalt was heated to 177° C. in a vessel and mixed with a paddle mixer using an Arrow mixer model #850 at a speed of 3 which produces approximately 300 RPM's. The temperature was maintained at about 177° C. throughout the experiment. A sufficient amount of non-chlorinated polymer was added to the hot asphalt to yield 6% polymer concentrate based on the weight of the mixture. The polymer was Kraton D118 KT which has low molecular weight and contains about 70% conjugated diene and is a non chlorinated SB-SBS linear polymer in the physical form of a porous pellet. Samples were removed from the mixing vessel at various times and placed on a glass microscope slide. These samples were tested on a Bruker Optics Verizon 70 FT-IR with a Pike industries Miracle ATR to determine butadiene absorbance around 966 cm⁻¹ (Method B area calculation) utilizing the OPUS version 6.0 software. The ‘% Incorporation’ is based on the following formula:

% Incorporation=(sample absorbance area)/(peak absorbance area, of the pre-dispersed polymer concentrate in asphalt)×100.

A pre-dispersed polymer concentrate in asphalt that contained 5% Suncor PG 58-28 and 95% Kraton D1118 KT was produced in accordance with the parent application, Ser. No. 12/173,571, incorporated herein by reference and the above data. The pre-dispersed polymer concentrate in asphalt was added to Suncor PG58-28 diluent asphalt under similar conditions to the above. A sufficient amount of pre-dispersed polymer concentrate in asphalt was added to achieve an identical 6% polymer content based on the weight of the asphalt.

The comparative results are shown in Table 1:

TABLE #1
Incorporation Time of Kraton D1118 KT and PC 1118

| Mix Time | Peak Area around 966 cm⁻¹ | | % Incorporated | |
|---|---|---|---|---|
| (min) | Kraton D1118 KT | PC1118 | Kraton D1118 KT | PC1118 |
| 10 | 0.0255 | 0.0373 | 12.5% | 18.3% |
| 20 | 0.0410 | 0.0685 | 20.1% | 33.6% |
| 30 | 0.0670 | 0.0977 | 32.8% | 47.9% |
| 45 | 0.0953 | 0.1365 | 46.7% | 66.9% |
| 60 | 0.1127 | 0.1707 | 55.2% | 83.7% |
| 90 | 0.1527 | 0.1840 | 74.8% | 90.2% |
| 120 | 0.1790 | 0.1953 | 87.7% | 95.8% |
| 150 | 0.1943 | 0.1947 | 95.3% | 95.4% |
| 180 | 0.1903 | 0.2000 | 93.3% | 98.0% |
| 240 | 0.1940 | 0.2040 | 95.1% | 100.0% |

### EXAMPLE #2

The process of example #1 was used with 6% Kraton D1101 KT polymer which is a non-chlorinated, medium molecular weight linear SBS polymer with 70% conjugated diene in the physical form of a porous pellet. Additionally, a pre-dispersed polymer concentrate in asphalt that contained 10% Suncor PG 58-28 and 90% Kraton D1101 KT was produced. A sufficient amount of pre-dispersed polymer concentrate in asphalt was added to achieve an identical 6% polymer content based on the weight of the asphalt.

The comparative results are shown in Table 2:

TABLE #2
Incorporation Time of Kraton D1101 KT and PC 1101

| Mix Time | Peak Area around 966 cm⁻¹ | | % Incorporated | |
|---|---|---|---|---|
| (min) | Kraton D1101 KT | PC1101 | Kraton D1101 KT | PC1101 |
| 10 | 0.0150 | 0.0185 | 6.1% | 7.5% |
| 20 | 0.0255 | 0.0543 | 10.4% | 22.1% |
| 30 | 0.0320 | 0.0727 | 13.0% | 29.5% |
| 45 | 0.0420 | 0.1148 | 17.1% | 46.6% |
| 60 | 0.0585 | 0.1630 | 23.8% | 66.2% |
| 90 | 0.0845 | 0.1937 | 34.3% | 78.6% |
| 120 | 0.1095 | 0.2103 | 44.5% | 85.4% |
| 150 | 0.1340 | 0.2087 | 54.4% | 84.7% |
| 180 | 0.1800 | 0.2295 | 73.1% | 93.2% |
| 240 | 0.1727 | 0.2160 | 70.1% | 87.7% |
| 300 | 0.2100 | 0.2463 | 85.3% | 100.0% |

### EXAMPLE #3

The process of example #1 was used with 6% Dynasol Solprene 416 polymer which is a non-chlorinated medium molecular weight radial SBS polymer with 70% conjugated diene in the physical form of a porous pellet. Additionally, a pre-dispersed polymer concentrate in asphalt that contained 10% Suncor PG 58-28 and 90% Dynasol Solprene 416 was produced. A sufficient amount of pre-dispersed polymer concentrate in asphalt was added to achieve an identical 6% polymer content based on the weight of the asphalt. Samples were collected at various times, tested and the data is detailed in Table #3.

TABLE #3
Incorporation Time of Solprene 416 and PC 416

| | | |
|---|---|---|
| | Peak Area around | |
| Mix Time | 966 cm⁻¹ | % Incorporated |

| (min) | Solprene 416 | PC 416 | Solprene 416 | PC 416 |
|---|---|---|---|---|
| 10 | 0.0310 | 0.0227 | 10.9% | 8.0% |
| 20 | 0.0508 | 0.0453 | 17.9% | 15.9% |
| 30 | 0.0703 | 0.0657 | 24.7% | 23.1% |
| 45 | 0.0953 | 0.1043 | 33.5% | 36.7% |
| 60 | 0.1167 | 0.1543 | 41.0% | 54.3% |
| 90 | 0.1853 | 0.2370 | 65.2% | 83.4% |
| 120 | 0.2250 | 0.2497 | 79.1% | 87.8% |
| 180 | 0.2465 | 0.2443 | 86.7% | 85.9% |
| 240 | 0.2373 | 0.2633 | 83.5% | 92.6% |
| 300 | 0.2473 | 0.2747 | 87.0% | 96.6% |
| 360 | 0.2568 | 0.2843 | 90.3% | 100.0% |

The incorporation time of examples #1, 2 and 3 were calculated by interpolation of the raw data. The results are shown in Table #4 along with the increased absorbance due to enhanced incorporation demonstrating a lack of cross linking in the pre-processing.

TABLE #4
Incorporation time and Increased Incorporation

| | Peak Absorbance | Incorporation Time | | |
|---|---|---|---|---|
| | around 966 cm⁻¹ | | Pre- | Increased |
| | Area | Polymer | dispersed | Absorbance |
| Kraton 1118 KT | 0.2040 | 129 | 89 | 4.90% |
| Kraton 1101 KT | 0.2463 | 298 | 248 | 14.80% |
| Solprene 416 | 0.2843 | 354 | 217 | 9.70% |

In all cases, the Incorporation time of the pre-dispersed polymer concentrate in asphalt was less than the corresponding porous pellet. Additionally, the level of incorporation was higher for all pre-dispersed polymer composites in asphalt relative to the corresponding porous pellet.

### EXAMPLE #4

A pre-processed polymer concentrate in asphalt that contained 5% Trigent PG 67-22 asphalt and 95% Kraton D1118 KT linear non-chlorinated SB-SBS polymer with 70% conjugated diene.

The pre-dispersed polymer concentrate in asphalt was produced with a co-rotating twin screw extruder in accordance to the following processing parameters:
specific energy of about 1.19 kw/kg,
residence time of about 11.6 seconds,
scalar shear quantity of about 3,142,
RPM of 600.

Further, the pre-dispersed polymer concentrate was pelletized by a Gala Under Water pelletizing device creating substantially spherical pellets about 0.25″ in diameter. The resulting pre-dispersed polymer concentrate in asphalt had a loose bulk density of 36.04 lbs/ft³.

The resulting pre-dispersed polymer concentrate in asphalt was added to 177° C. Trigent diluent asphalt while mixing to produce 6% polymer modified asphalt. This was accomplished at a lull scale processing facility with standard handling and low shear mixing equipment.

Similarly, 6% of Kraton D1118 KT polymer with a loose bulk density of 26.25 lbs/ft³ was added to 177° C. Trigent asphalt under the same mixing conditions, mixing vessel, and processing the same batch size as a direct comparison. The results are as follows.

TABLE # 5
Field comparison of addition and incorporation time

| | Addition | Incorporation | Batch Cycle |
|---|---|---|---|
| | Time (min) | Time (min) | Time (min) |
| Kraton D1118 | 120 | 150 | 270 |
| PC 1118 | 60 | 60 | 120 |
| Cycle Time Improvement | | | 56% |

*limited by the speed of the ground transport system

The Kraton D1118 KT was added as fast as possible while avoiding agglomeration on the fluid surface. The time was recorded to fully charge the polymer into the asphalt tank and this was considered the ‘Addition Time’. The incorporation time starts after full addition of the polymer. The Total Time is the sum of the Addition and Incorporation times.

The pre-dispersed polymer concentrate in asphalt PC 1118 KT was added as fast as the ground transport systems could handle the material without any signs of agglomeration in the diluent asphalt. Addition time can be reduced, perhaps significantly with a slight redesign of the handling equipment. The pre-dispersed polymer concentrate reduced the batch cycle time by 56%.

The pre-dispersed polymer concentrate in asphalt drastically changed the physical properties of the pellet. Table #6 demonstrates the significant change in loose bulk density.

TABLE #6
Loose Bulk Density Comparison

| Kraton D1118 KT | PC 1118 | Increased |
|---|---|---|
| lbs/ft³ | lbs/ft³ | Bulk Density |
| 26.25 | 36.04 | 37% |
| Solprene 416 | PC 416 | |
| 21.35 | 32.66 | 53% |

In all cases, the pre-dispersed polymer concentrate containing >26% polymer content in asphalt demonstrated a much higher loose bulk density. Surprisingly, the incorporation time of the higher loose bulk density pre-dispersed polymer in asphalt composite was significantly less than either the porous or powdered polymers. Additionally, the pre-dispersed polymer concentrates in asphalt can be handled easier reducing the addition time leading to a significantly lower total time to incorporate polymers into asphalt. Finally, the pre-processed polymer composite completely incorporated into asphalt demonstrating a lack of cross linking during processing in the mega shear device.

It should be understood and appreciated that any embodiment of the pre-dispersed polymer concentrate in asphalt composition described herein can be implemented in the method for producing a pre-dispersed polymer concentrate in asphalt described above.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A pre-processed polymer concentrate in binder comprising:
a binder; and
at least one polymer that contains at least 60% conjugated diene where the polymer comprises greater than 26% by weight of the pre-processed polymer concentrate in binder,
where the pre-processed polymer concentrate in binder is capable of incorporating quickly into diluent binder under low shear conditions and where the pre-processed polymer concentrate in binder does not comprise chlorinated polymer.

2. The pre-processed polymer concentrate in binder of claim 1 where the polymer comprises greater than 50% by weight of the pre-processed polymer concentrate in binder.

3. The pre-processed polymer concentrate in binder of claim 1 where the polymer comprises greater than 75% by weight of the pre-processed polymer concentrate in binder.

4. The pre-processed polymer concentrate in binder of claim 1 where the polymer comprises greater than 85% by weight of the pre-processed polymer concentrate in binder.

5. The pre-processed polymer concentrate in binder of claim 1 where the pre-processed polymer concentrate is made into pellets that maintain an individual pellet shape.

6. The pre-processed polymer concentrate in binder of claim 1 where the pre-processed polymer concentrate has a loose bulk density of greater than 28 lbs/ft³.

7. The pre-processed polymer concentrate in binder of claim 1 where the pre-processed polymer concentrate has a loose bulk density of greater than 30 lbs/ft³.

8. The pre-processed polymer concentrate in binder of claim 1 where the pre-processed polymer concentrate has a loose bulk density of greater than 32 lbs/ft³.

9. The pre-processed polymer concentrate in hinder of claim 1 where the pre-processed polymer concentrate in binder is stable at normal temperatures and can be stored and transported without heating.

10. The pre-processed polymer concentrate in binder of claim 1 where the binder comprises greater than 25% bituminous asphalt.

11. The pre-processed polymer concentrate in binder of claim 1 where the binder comprises used motor oil, re-refined used motor oil constituents and/or byproducts.

12. The pre-processed polymer concentrate in binder of claim 1 where the binder comprises bio-based oils, crude or refined products, and/or byproducts.

13. A method, of producing a pre-processed polymer concentrate in binder comprising:
adding a binder to a mega shear device; and
adding at least one polymer that contains at least 60% conjugated diene to the mega shear device in a sufficient quantity to produce a pre-processed polymer concentrate in binder with greater than 26% polymer by weight of the pre-processed polymer concentrate in binder, where the pre-processed polymer concentrate in binder is capable of incorporating quickly into diluent binder under low shear conditions, and where the pre-processed polymer concentrate in binder does not comprise chlorinated polymer.

14. The method of claim 13 wherein said binder and said at least one polymer are subjected to mixing where scalar shear quantity is greater than about 250.

15. The method of claim 13 wherein said binder and said at least one polymer are subjected to mixing where scalar shear quantity is greater than about 1,000.

16. The method of claim 13 wherein said binder and said at least one polymer are subjected to mixing where scalar shear quantity is greater than about 1,500.

17. The method of claim 13 wherein said binder and said at least one polymer are subjected to mixing where energy utilized is greater than about 0.025 kW/kg energy in the high shear device.

18. The method of claim 13 wherein said binder and said at least one polymer are subjected to mixing where energy utilized is greater than about 0.05 kW/kg energy in the high shear device.

19. The method of claim 13 wherein said binder and said at least one polymer are subjected to mixing where energy utilized is greater than about 0.10 kW/kg energy in the high shear device.

20. The method of claim 13 where said binder and said at least one polymer are processed at greater than 100 psi.

21. The method of claim 13 further comprising making the pre-processed polymer concentrate in binder into pellets that maintain an individual pellet shape.

22. The method of claim 13 where the pre-processed polymer concentrate has a loose bulk density of greater than 28 lbs/ft³.

23. The method of claim 13 where the pre-processed polymer concentrate has a loose bulk density of greater than 30 lbs/ft³.

24. The method of claim 13 where the pre-processed polymer concentrate has a loose bulk density of greater than 32 lbs/ft³.

25. The method of claim 13 where the pre-processed polymer concentrate in binder is stable at normal temperatures and can be stored and transported without heating.

26. The method of claim 13 where the binder comprises greater than 25% bituminous asphalt.

27. The method of claim 13 where the hinder comprises used motor oil, re-refined used motor oil constituents and/or byproducts.

28. The method of claim 13 where the binder comprises bio-based oils, crude or refined products, and/or byproducts.

29. The method of claim 13 where the pre-processed polymer concentrate in binder can be dispersed in diluent binder in less than three hours.

30. The method of claim 13 where the pre-processed polymer concentrate in binder can be dispersed in diluent binder in less than two hours.

31. The method of claim 13 where the pre-processed polymer concentrate in binder can be dispersed in diulent binder in less than one hour.

32. A pre-processed polymer concentrate in binder produced according to the method of claim 13.
